(19) United States
(12) Patent Application Publication
(10) Pub. No.: US 2007/0208776 A1
(43) Pub. Date: Sep. 6, 2007

(54) Assignment of metadata

(75) Inventors: Benjamin L. Perry, Seattle, WA (US); David R. Parlin, Redmond, WA (US); Eric J. Wright, Seattle, WA (US); Jae Pum Park, Sammamish, WA (US); Karen K. Wong, Seattle, WA (US); Scott E. Dart, Redmond, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/368,969

(22) Filed: Mar. 6, 2006

(51) Int. Cl. G06F 7/00

(52) U.S. Cl. 707/104.1

(57) ABSTRACT

A system, a user interface and computer-readable media for associating metadata with digital media. Tags are associated with single-action user inputs. Entry of one of the single-action user inputs is detected. The tag associated with the detected input is stored as metadata associated with a selected item of digital media.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

In recent years, computer users have become more and more reliant upon personal computers to store and present a wide range of digital media. For example, users often utilize their computers to store and interact with digital images. As millions of families now use digital cameras to snap thousands of images each year, these images are often stored and organized on their personal computers.

With the increased use of computers to store digital media, greater importance is placed on the efficient retrieval of desired information. For example, metadata is often used to aid in the location of desired media. Metadata consists of information relating to and describing the content portion of a file. Metadata is typically not the data of primary interest to a viewer of the media. Rather, metadata is supporting information that provides context and explanatory information about the underlying media. Metadata may include information such as time, date, author, subject matter and comments. For example, a digital image may include metadata indicating the date the image was taken, the names of the people in the image and the type of camera that generated the image. The discrete pieces of information stored as metadata are often referred to as “tags.” For example, a tag may be the keyword “John Smith,” and images depicting John Smith may receive this tag.

Metadata may be created in a variety of different ways. It may be generated when a media file is created or edited. For example, the user or a device may assign metadata when the media is initially recorded. Alternatively, a user may enter metadata via a metadata editor interface provided by a personal computer.

With the increasingly important role metadata plays in interacting with desired media, it is important that computer users be provided tools for quickly and easily applying desired metadata. Without such tools, users may select not to create metadata, and, thus, they will not be able to locate media of interest. For example, metadata may indicate a certain person is shown in various digital images. Without this metadata, a user would have to examine the images one-by-one to locate images with this person.

A number of existing interfaces are capable of assigning or “tagging” digital media with metadata. These existing interfaces, however, require the user to navigate among various menus and/or options before entry of a metadata text is permitted. Further, metadata editor interfaces today typically rely on keyboard entry of metadata text. Such navigation and keyboard entry can be time-consuming, especially with large sets of items requiring application of metadata.

### SUMMARY

The present invention meets the above needs and overcomes one or more deficiencies in the prior art by providing systems and methods for associating metadata with digital media. Tags that may be stored as metadata are associated with single-action user inputs. For example, a tag may be associated with user selection of an icon. Entry of one of the single-action user inputs is detected. For example, a user may select the icon with a mouse click. The tag associated with the detected input is stored as metadata associated with a selected item of digital media.

It should be noted that this Summary is provided to generally introduce the reader to one or more select concepts described below in the Detailed Description in a simplified form. This Summary is not intended to identify key and/or required features of the claimed subject matter, nor is it intended to be used as an aid in determining the scope of the claimed subject matter.

### BRIEF DESCRIPTION OF THE SEVERAL VIEWS OF THE DRAWING

The present invention is described in detail below with reference to the attached drawing figures, wherein:

FIG. 1 is a block diagram of an exemplary computing system environment suitable for use in implementing one or more embodiments of present invention;

FIG. 2 illustrates a method in accordance with one embodiment of the present invention for associating metadata with digital media;

FIGS. 3A-3F illustrate a graphical user interface in accordance with one embodiment of the present invention in which tags are is applied to digital media;

FIGS. 4A-4C illustrate a graphical user interface in accordance with one embodiment of the present invention for managing the assignment of metadata applied to digital media; and

FIG. 5 is a schematic diagram illustrating a system for associating metadata with digital media in accordance with one embodiment of the present invention.

### DETAILED DESCRIPTION

The subject matter of the present invention is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described. Further, the present invention is described in detail below with reference to the attached drawing figures, which are incorporated in their entirety by reference herein.

The present invention provides an improved system and method for associating metadata with digital media. An exemplary operating environment for the present invention is described below.

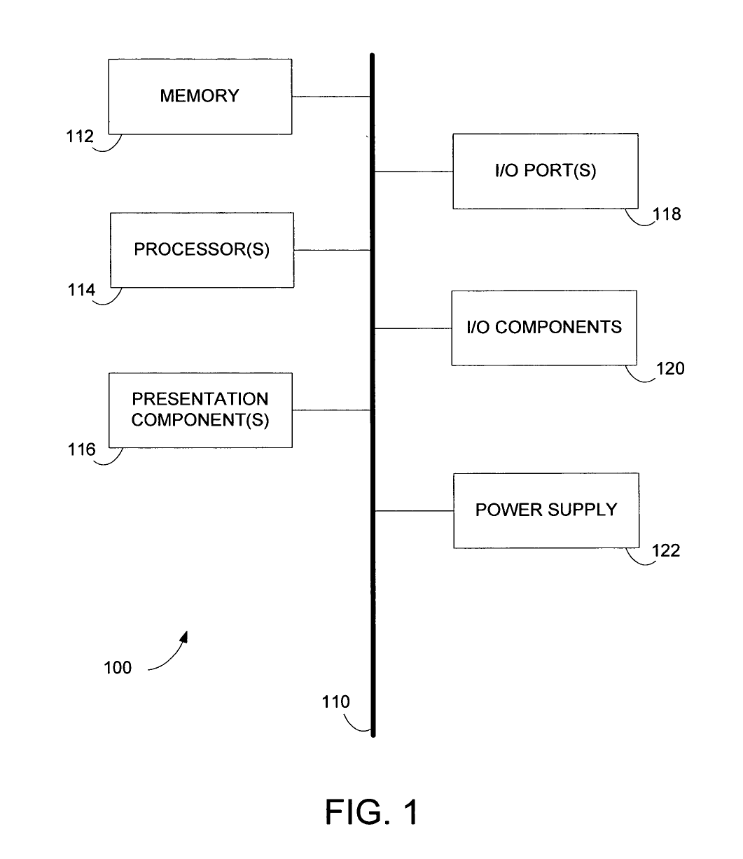

Referring initially to FIG. 1 in particular, an exemplary operating environment for implementing the present invention is shown and designated generally as computing device 100. The computing device 100 is but one example of a suitable computing environment and is not intended to suggest any limitation as to the scope of use or functionality of the invention. Neither should the computing-environment 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following elements: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. It should be noted that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

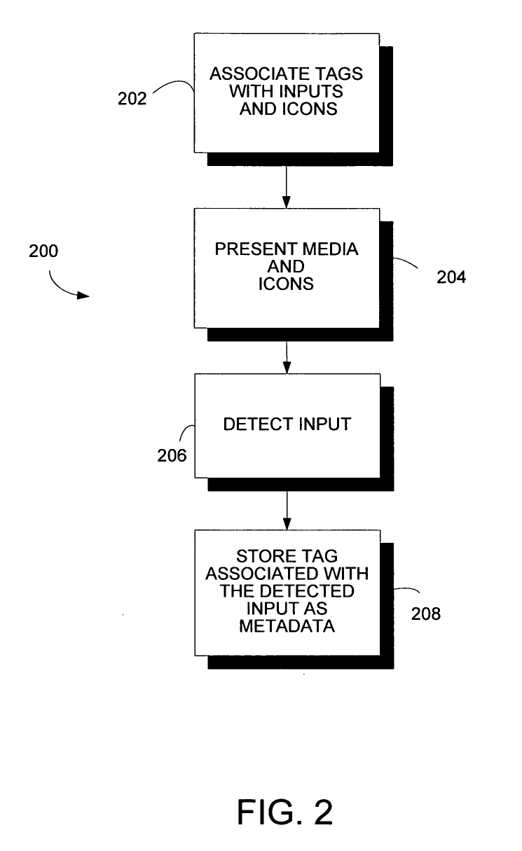

FIG. 2 illustrates a method 200 for associating metadata with an item of digital media. The item of digital media may be, for example, an image, a video, a word-processing document or a slide presentation. Those skilled in the art will appreciate that the present invention is not limited to any one type of digital media, and the method 200 may associate metadata with a variety of media types.

At 202, the method 200 associates tags with single-action user inputs. A tag may include any information acceptable for being associated as metadata with an item as media. A tag may identify keywords related to the subject matter depicted by the media. For example, the keywords may identify the people in an image or events associated with the image. As will be appreciated by those skilled in the art, keyword-based tags may be used to organize or to locate an item of media.

A tag may also express an action to be performed with respect to the digital media. For example, a user may desire for an image be printed or emailed. Accordingly, a tag may indicate the commands “email” or “print.” Subsequently, these commands may be used to trigger the emailing or printing of the image. As will be appreciated by those skilled in the art, a tag may indicate a variety of actions that a user intends to be performed with respect to the media.

Tags may originate from a variety of sources. For example, tags may be automatically created (i.e., predefined) by a software provider or other source. The tags may also be user-defined. These user-defined tags may be created by the user and can be associated with an icon. As another example, tags may be automatically generated based on user actions. For example, an automatically generated tag may indicate the date a digital image was last printed.

As previously mentioned, the method 200 associates tags with single-action user inputs. Any number of single-action user inputs are known in the art, and these inputs may vary based on input device. For example, a single-action user input may be the entry of a “hot key” keystroke. A hot key is a keystroke entry on a computer keyboard that indicates user assignment/association of a tag. A hot key may be associated with a single keyboard key or a combination of keyboard keys that are pressed simultaneously. As another example, the single-action user input may relate to the selection of an icon or widget displayed in a graphical interface. Such selection may be made, for example, with a mouse click or with a stylus input. It should be noted that the term icon, as it used herein, refers to any graphical object that may be presented to a user and associated with a tag. A single-action user input may also be associated with a specialized button on, for example, a device, a computer keyboard or a remote control. For example, a digital camera may have an “email” button to be pressed when a user desires to tag a picture for emailing. Such specialized buttons/keys may be incorporated into any number of devices or keyboards.

At 204, the method 200 presents the item of digital media to the user. Any visual representation the digital media may be acceptable for presentation at 204. For example, a digital image may be displayed if the media is a picture or a video. The method 200 also presents icons associated with the tags. Any number of icons may be presented to the user, and these icons may be customized to reflect commonly used tags. For example, an icon may be associated with the name of a user's child. Accordingly, each image that depicts the child may be quickly tagged with the child's name via selection of this icon.

The method 200, at 206, detects entry of a single-action user input. For example, a hot key keystroke may be detected, or the method 200 may detect a mouse click selecting an icon. Upon detection of the user input, the method 200, at 208, stores the tag associated with the detected input as metadata along with the item of digital media. A variety of techniques exist in the art for storing metadata with media. In one embodiment, the metadata may be used to identify key aspects of the underlying media. In this manner, items of interest may be located by searching for items having a certain tag. As will be appreciated by those skilled in the art, because the tags are stored with the underlying files, various applications and/or an operating system may access and utilize the metadata information.

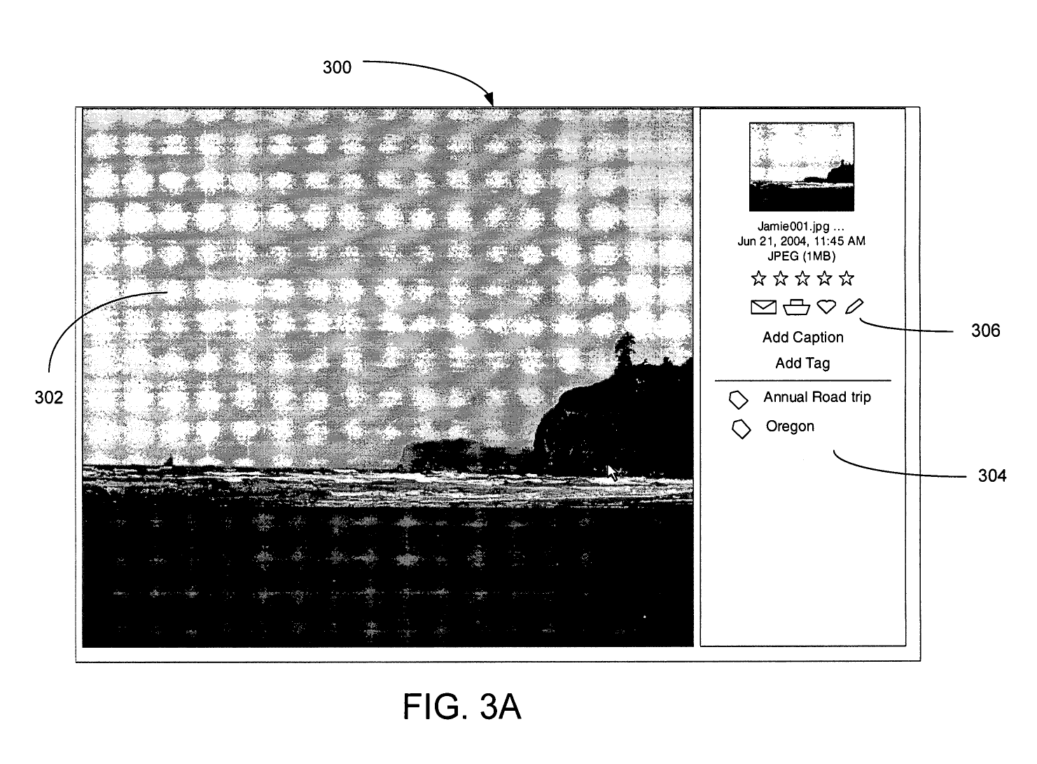

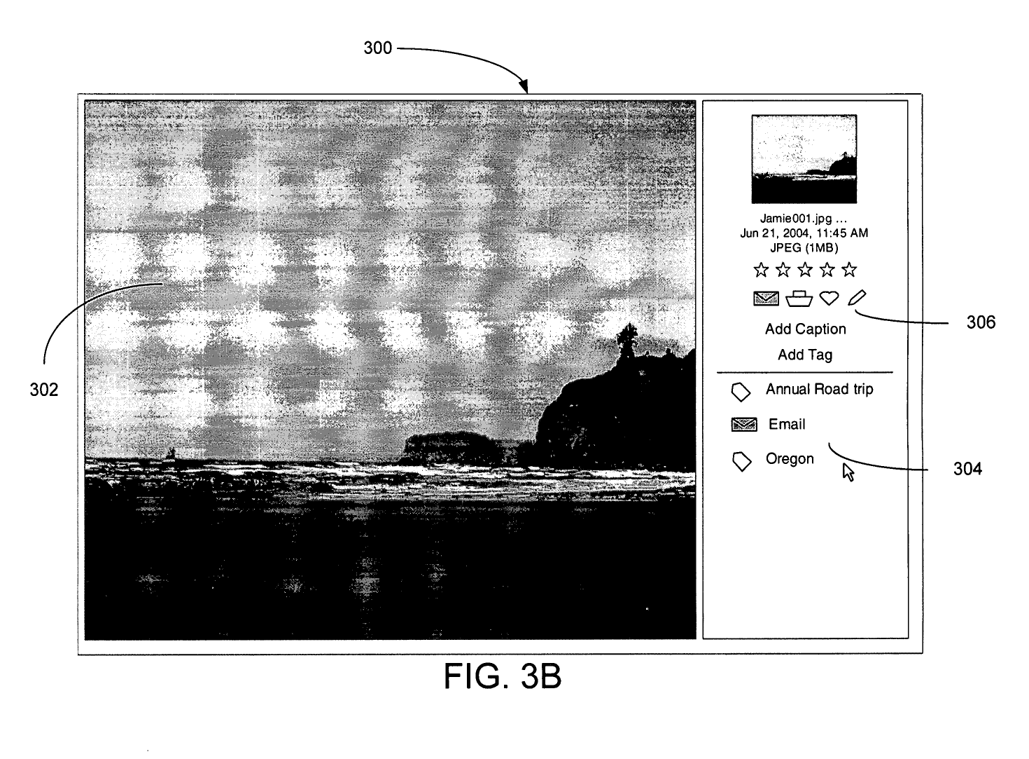

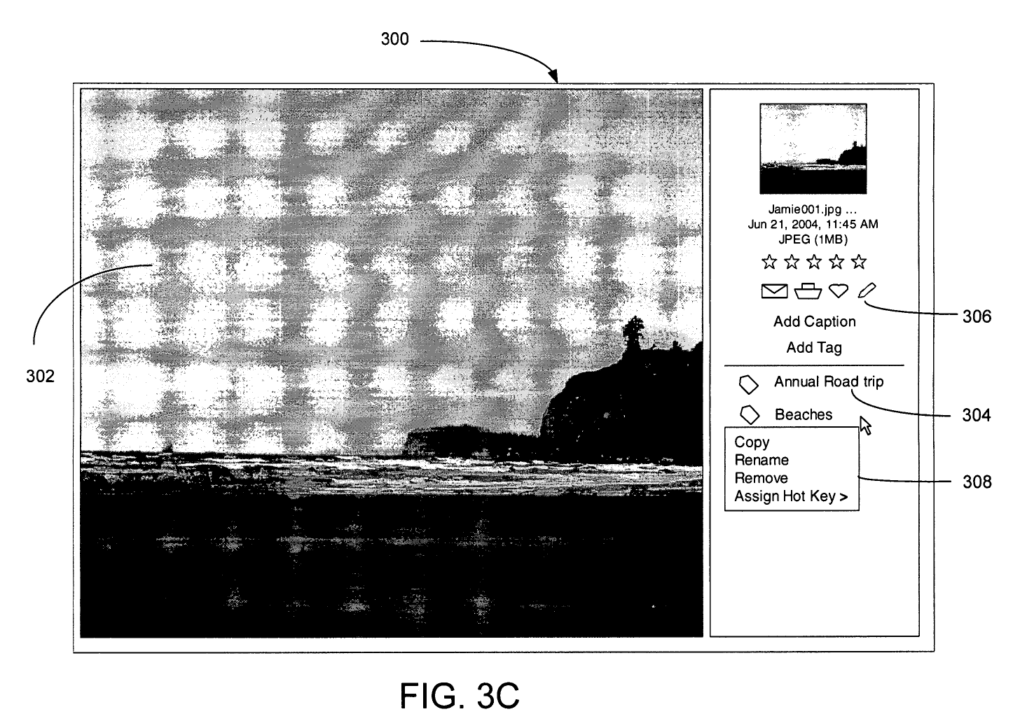

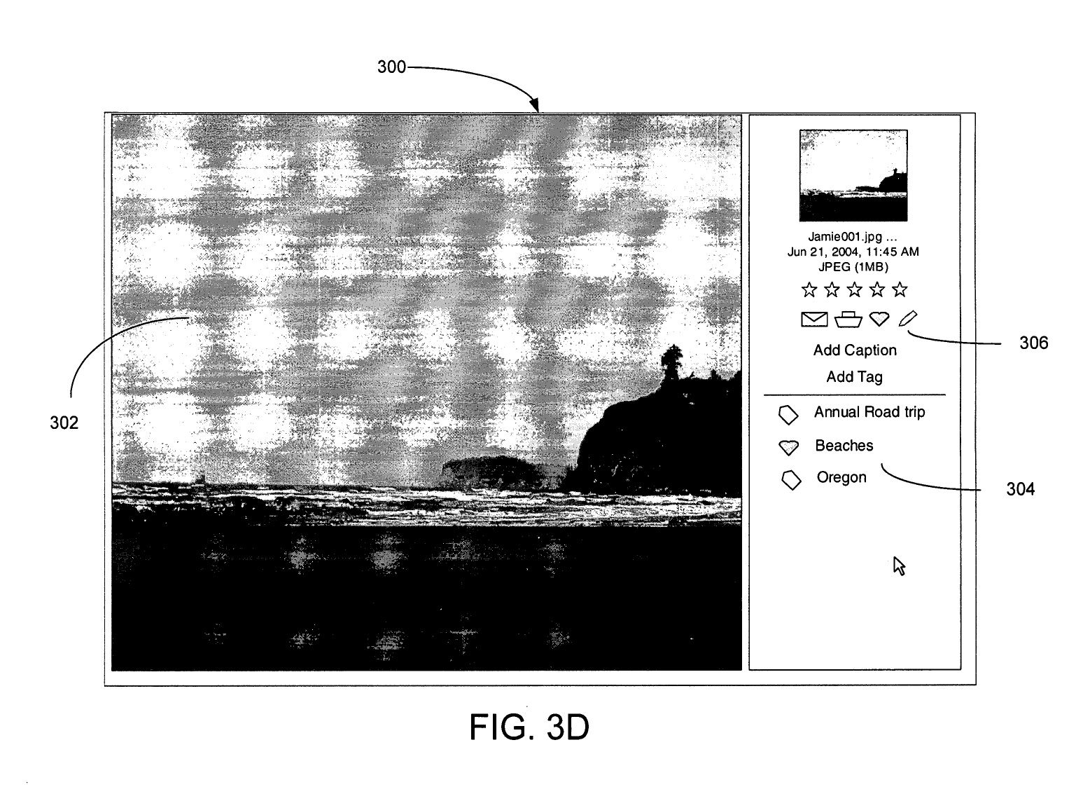

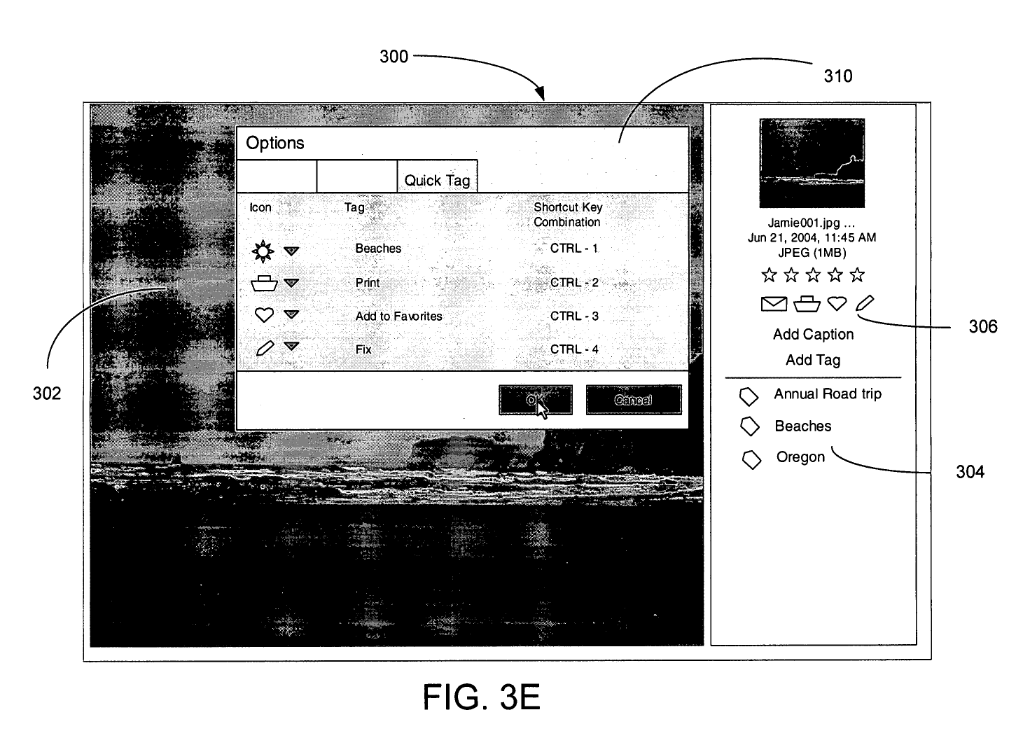

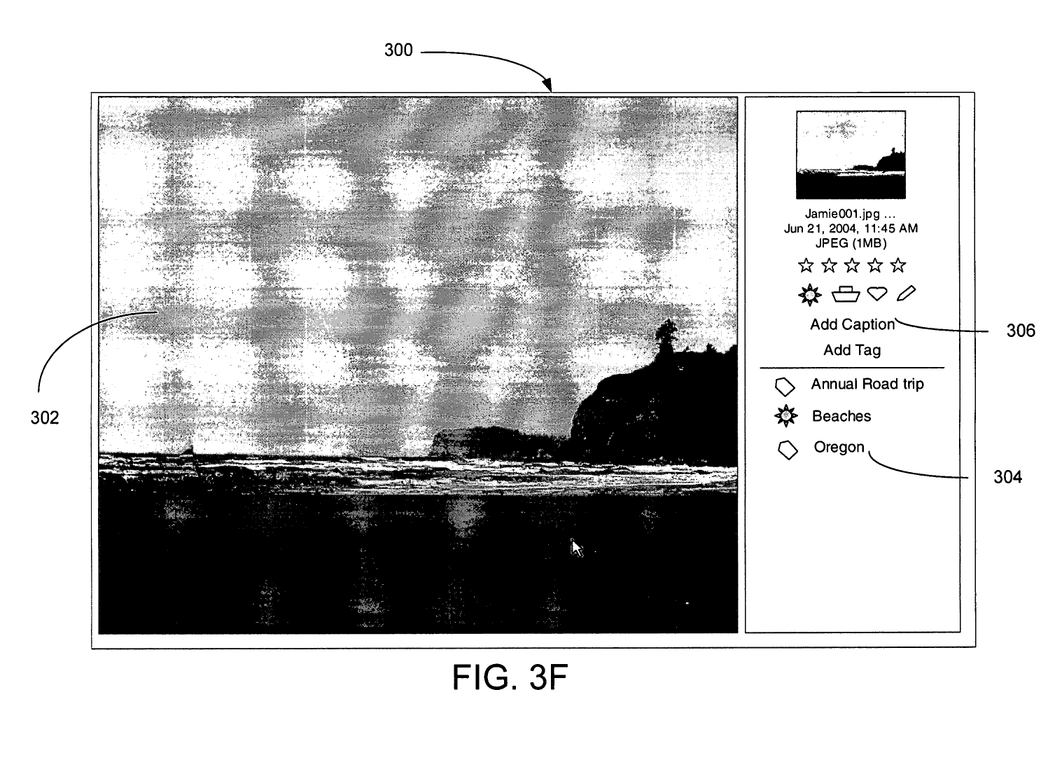

FIGS. 3A-3F are screen displays of a graphical user interface in accordance with one embodiment of the present invention. Turning initially to FIG. 3A, a screen display 300 is presented. The screen display 300 may be presented on any number of devices. For example, the screen display 300 may be presented on a PC monitor, a television screen or a portable device used for storing/viewing metadata (e.g., a portable media center). The screen display 300 includes an image presentation area 302. The image presentation area 302 may present an image selected to receive tags and/or may present a slideshow of images.

The screen display 300 also includes a tag presentation area 304. The tags in the tag presentation area 304 may identify the subject matter of the presented image and/or may list actions to be performed with respect to the image. The tags may be derived from any number of inputs and/or sources. For example, a user may manually enter a tag in response to an image's display, or a tag may be created in response to user entry of a single-action user input. Alternatively, a tag may be communicated from a device (e.g., a digital camera) along with the presented image.

A tag icon area 306 is also included on the screen display 300. The tag icon area 306 includes four icons, and each of these icons is associated with a tag. Those skilled in the art will appreciate that any number of icons may be displayed in the tag icon area 306 and that these icons may have various associated tags. For example, an icon resembling an envelope resides in the tag icon area 306. This envelope icon may be associated with a tag containing the word “Email.” When a user desires to email the image presented in the image presentation area 302, the user may select the envelope icon to associate an “Email” tag with the presented image.

FIG. 3B illustrates the screen display 300 after the user has selected the envelope icon from the tag icon area 306. For example, the user may have clicked a mouse button while the mouse pointer was hovering over the envelope icon. In response to this input, the tag presentation area 304 now displays an “Email” tag and the envelope icon. Through the single act of selecting the envelope icon in the tag icon area 306, the tag “Email” has been assigned to the selected image.

FIG. 3C illustrates the screen display 300 after a user has selected to view options related to a “Beaches” tag, which is presented in the tag presentation area 304. In response to this selection, a tag editor 308 is presented. For example, the tag editor 308 may allow the user to rename or remove the “Beaches” tag. Further, the tag editor 308 may allow the user to assign a hot key keystroke combination to the “Beaches” tag. For example, the user may select to assign the hot key combination of CTRL and 3 to the “Beaches” tag.

The tag editor 308 may also allow the user to associate an icon from the tag icon area 306 with the “Beaches” tag. As illustrated by FIG. 3D, the “Beaches” tag in the tag presentation area 304 is now displayed with a heart icon, and the heart icon in the tag icon area 306 is colored to indicate its selection. The heart icon may also remain highlighted for other media having a “Beaches” tag. So if the user iterates through other photos that have the “Beaches” tag, the heart icon may be highlighted for these images as well. In one embodiment, the heart icon remains associated with the “Beaches” tag, and this icon may be used to assign the “Beaches” tag to subsequently displayed images.

Turning to FIG. 3E, an icon configuration interface 310 is presented within the screen display 300. The icon configuration interface 310 allows the user to change various properties associated with the icons presented in the tag icon area 306. The icon configuration interface 310 may allow a user to select the shape of the icon. Also, the user may enter a new tag to be associated with an icon, or the user may change the hot key assignment. For example, the first icon in the tag icon area 306 is presently an envelope icon that is associated with an “Email” tag. A user may wish to replace this “Email” tag with a “Beaches” tag. FIG. 3E provides an example of how the icon configuration interface 310 may be used to make this change. As shown in the icon configuration interface 310, the user has selected to change the first icon from an envelope icon to a sun icon. Further, the tag “Beaches” is now associated with this icon. FIG. 3F displays the result of this modification. In FIG. 3F, the first icon in the tag icon area 306 is now a sun icon, and the “Beaches” tag in the tag presentation area 304 now is displayed with the sun icon. Those skilled in the art will appreciate that the properties associated with the various icons may be modification by any number of interfaces and that the user may be afforded a variety of control for use in customizing the icons.

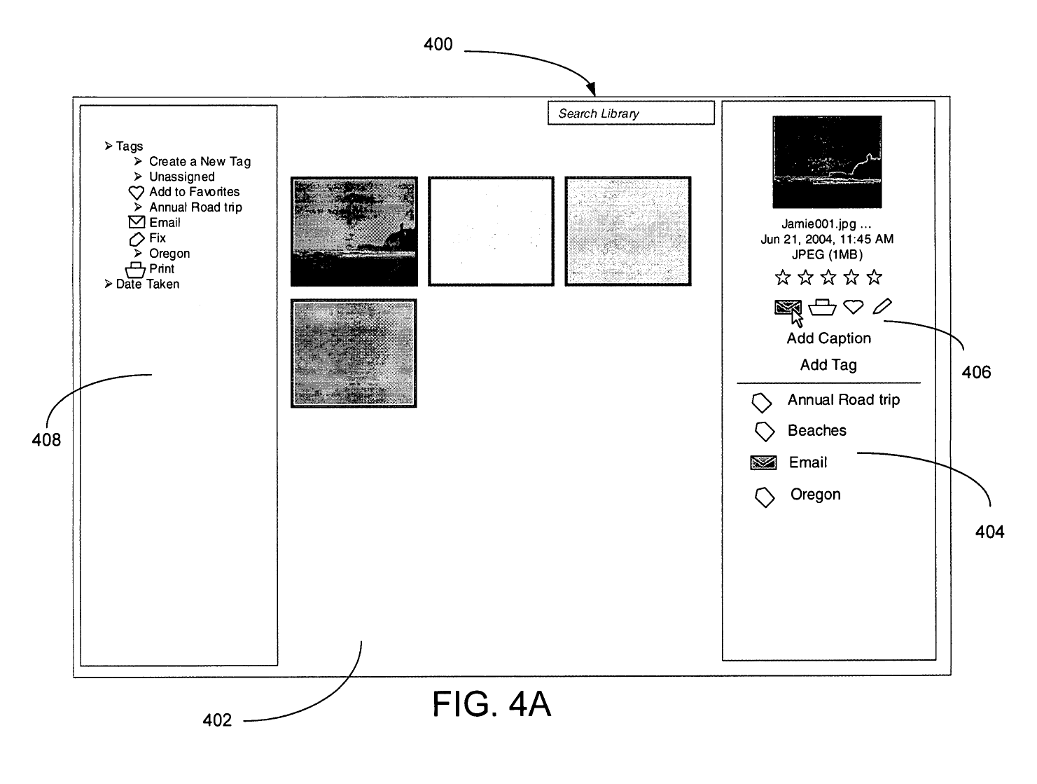

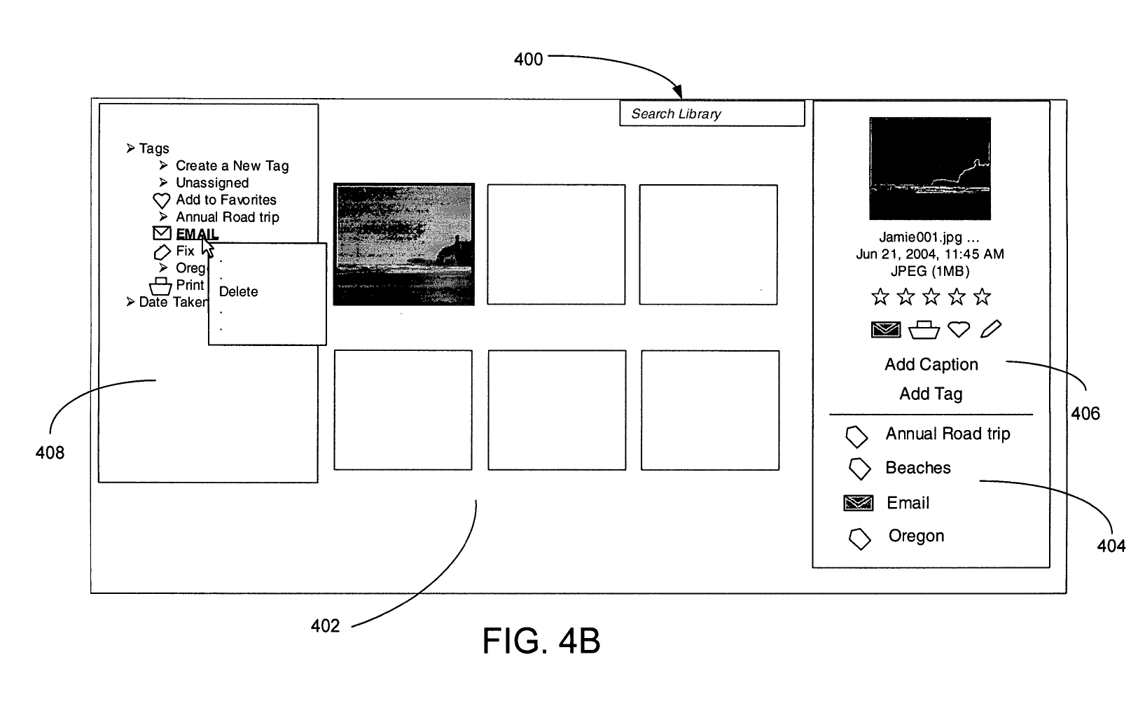

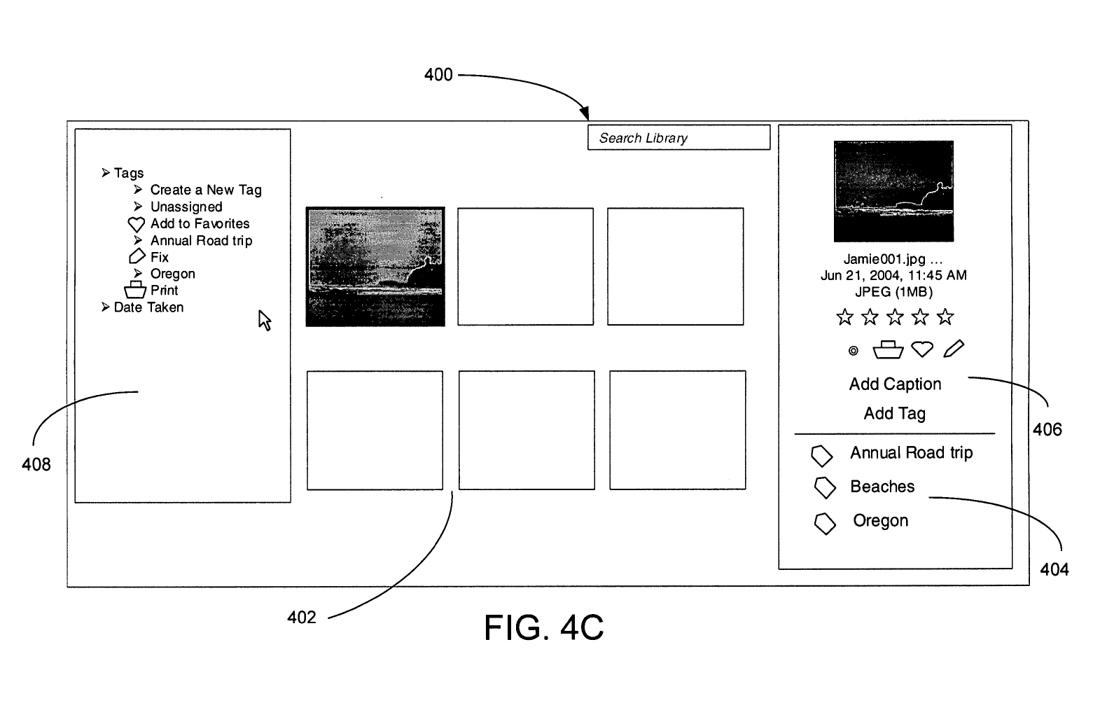

FIGS. 4A-4C are screen displays of a graphical user interface in accordance with one embodiment of the present invention. Turning initially to FIG. 4A, a screen display 400 is presented. The screen display 400 includes a presentation area 402. In the presentation area 402, multiple images are presented. As will be appreciated by those skilled in the art, the display of multiple images may allow a user to organize and interact with their images in an efficient manner.

The screen display 400 also includes a tag presentation area 404 and a tag icon area 406. The tag presentation area 404 and the tag icon area 406 may be similar to the tag presentation area 304 and the tag icon area 306 of FIGS. 3A-3F. In one embodiment, the tag presentation area 404 may display the tags associated with a selected image that is presented in the presentation area 402. Further, the tag presentation area 404 and/or the tag icon area 406 may indicate characteristics shared by the presented images. For example, each of the presented images may have an “Email” tag. So the email icon in the tag presentation area 404 and in the tag icon area 406 is presented differently to indicate this shared property.

A tree display area 408 is also included in the screen display 400. The tree display area 408 may include controls that allow a user to navigate among and organize their images. For example, the tree display area 408 includes a “Date Taken” entry. Upon user selection, this entry may be expanded to list various dates in which photos were taken. By selecting a date, each of the photos taken that day will be displayed in the presentation area 402. Such tree interfaces are well known in the art.

One of the entries in the tree display area 408 is a “Tags” entry. When expanded, this entry provides various tag-related options. For example, the tree display area 408 may allow the user to create a new tag. The icons presented in the tag icon area 406 are also presented in the tree display area 408. When a user selects an icon from the tree, the images that have a tag associated with the selected icon are presented in the presentation area 402.

The screen display 400 may allow the user to alter the tags of multiple images at the same time. For example, images having the “Email” tag may be presented in the presentation area 402. After emailing these images, the user may wish to delete the “Email” tag from each image, and the screen display 400 may provide a control allowing such removal from multiple images at the same time. Further, the user may wish to delete the “Email” tag from all images. As shown on FIG. 4B, the user may select to remove the “Email” tag from the tree display area 408. The result of such removal is shown on FIG. 4C. As shown in this figure, the “Email” tag has been removed from the tree display area 408 and from the tag icon area 406. Also, as indicated by the tag presentation area 404, the “Email” tag has been removed from the various images. In one embodiment, the user may rename a selected tag by changing the tag's name as it appears in the tree display area 408. Such a change may cause the tag to be altered for each image having the selected tag. For instance, a “Beaches” tag may be changed to a “U.S. Beaches” tag, and this change may be reflected in each of the images that previously had the “Beaches” tag. As will be appreciated by those skilled in the art, the tree display area 408 may allow the user to add, delete and/or alter the tags of multiple images at the same time.

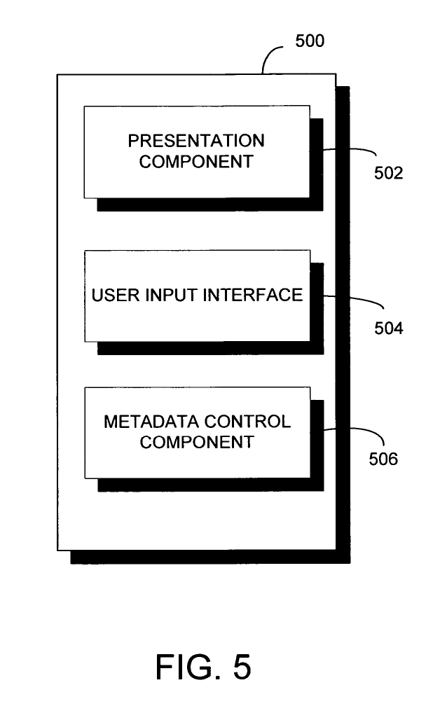

FIG. 5 illustrates a system 500 for associating metadata with digital media. The system 500 includes a presentation component 502. The presentation component 502 may be configured to present a visual representation of an item of digital media. For example, one or more digital images may be presented in a user interface. The user interface may be similar to the screen display 300 shown on FIGS. 3A-3F. The presentation component 502 may also be configured to provide one or more controls for user selection. In one embodiment, a portion of these controls may be associated with one or more tags. For example, a set of icons may be presented, and each of these icons may be associated with a tag. Accordingly, user selection of one of these icons will represent selection of the associated tag. It is important to note that not all controls must be presented visually. For example, a hotkey or a button on a device may be considered a control and may indicate selection of an associated tag. For example, to allow assignment of eight different tags, the presentation component 502 may present four icons and provide four hotkeys. User selection of one of these eight controls (i.e., icons or hotkeys) may represent selection of one of the eight tags.

The system 500 also includes a user input interface 504. The user input interface 504 may be configured to receive single-action user inputs selecting one of the controls. For example, the user input interface 504 may receive a mouse click selecting an icon. As another example, the user input interface 504 may detect entry of a keystroke combination associated with a hotkey. As will be appreciated by those skilled in the art, any number of single-action user inputs may be entered by a user and received by the input interface 504.

The system 500 further includes a metadata control component 506. The metadata control component 506 may be configured to store tags as metadata with an identified item of digital media. The metadata control component 506 may determine whether one or more tags are associated with an input detected by the input interface 504. In one embodiment, a set of multiple tags may be associated with a single input. In this embodiment, the received single-action user input may indicate a user's desire to assign a set of multiple tags to an item of digital media.

If such tags are associated, the metadata control component 506 may incorporate the tag(s) into the media file as metadata, and the file may be stored in a data store. As will be appreciated by those skilled in the art, the metadata control component 506 may utilize any number of known data storage techniques to associate the metadata with the underlying media file. By storing tags as metadata, the tags will persist with the media, and any number of computer programs may use the tags when interacting with the media.

Alternative embodiments and implementations of the present invention will become apparent to those skilled in the art to which it pertains upon review of the specification, including the drawing figures. Accordingly, the scope of the present invention is defined by the appended claims rather than the foregoing description.

The invention claimed is:

1. One or more computer-readable media having computer-useable instructions embodied thereon to perform a method for associating metadata with digital media, said method comprising:
associating one or more tags with one or more single-action user inputs;
detecting at least one of said one or more single-action user inputs; and
storing at least one of said one or more tags as metadata associated with one or more selected items of digital media.

2. The media of claim 1, wherein at least a portion of said one or more selected items of digital media is a digital image or a digital video.

3. The media of claim 1, wherein at least one of said one or more single-action user inputs is a mouse click.

4. The media of claim 3, wherein said mouse click indicates user selection of an icon associated with a set of tags, wherein said set of tags is comprised of a plurality of said one or more tags.

5. The media of claim 1, wherein at least one of said one or more single-action user inputs is a keystroke or a combination of keystrokes.

6. The media of claim 1, wherein said method further comprises presenting one or more icons and said selected item of digital media to a user, wherein each of at least a portion of said one or more icons are associated with at least one of said one or more tags.

7. A computer system for associating metadata with digital media, said system comprising:
a presentation component configured to present a visual representation of one or more items of digital media to a user and further configured to provide one or more controls for user selection, wherein each of at least a portion of said one or more controls are associated with one or more tags;
a user input interface configured to receive one or more single-action user inputs selecting at least one of said one or more controls; and
a metadata control component configured to store at least one of said one or more tags as metadata associated with at least a portion of said one or more items of digital media in response to at least a portion of said one or more single-action user inputs.

8. The system of claim 7, wherein at least a portion of said one or more controls are associated with one or more icons presented by said presentation component.

9. The system of claim 7, wherein at least one of said one or more single-action user inputs is at least one of a mouse click, a keystroke or a combination of keystrokes.

10. The system of claim 7, wherein at least a portion of said one or more tags indicates one or more keywords to be associated as metadata with at least a portion of said one or more items of digital media.

11. The system of claim 7, wherein at least a portion of said one or more tags indicates one or more actions to be performed with respect to at least a portion of said one or more items of digital media.

12. A user interface embodied on one or more computer-readable media and executable on a computer, said user interface comprising:
an item presentation area for displaying one or more items of digital media;
a user input interface configured to receive one or more single-action user inputs indicating a selection to apply one or more tags to at least one of said one or more items of digital media; and
a tag icon area for displaying one or more icons selectable by at least one of said one or more single-action user inputs, wherein each of at least a portion of said one or more icons is associated with at least one of said one or more tags.

13. The user interface of claim 12, further comprising a tag presentation area for displaying at least one tag selected to be stored as metadata with at least of said one or more items of digital media.

14. The user interface of claim 12, further comprising an icon configuration interface for receiving one or more user inputs selecting one or more properties to be associated with at least one of said one or more icons.

15. The user interface of claim 14, wherein said icon configuration interface is configured to receive text to be utilized as one of said one or more tags.

16. The user interface of claim 12, wherein at least one of said one or more items of digital media is a digital image.

17. The user interface of claim 12, wherein at least a portion of said one or more single-action user inputs is a selection of at least one of said one or more icons.

18. The user interface of claim 12, wherein at least a portion of said one or more single-action user inputs is a keystroke or a combination of keystrokes.

19. The user interface of claim 12, wherein said user input interface is further configured to receive one or more user inputs indicating a selection to delete one or more tags from at least one of said one or more items of digital media.

20. The user interface of claim 12, wherein at least a portion of said one or more tags indicates one or more keywords or one or more actions.
